(19) United States
(12) Patent Application Publication
(10) Pub. No.: US 2007/0004451 A1
(43) Pub. Date: Jan. 4, 2007

(54) Controlling functions of a handheld multifunction device

(76) Inventor: Eric C. Anderson, Gardnerville, NV (US)

Correspondence Address: SCENERA RESEARCH, LLC, 111 Corning Road, Suite 220, Cary, NC, 27518, US

(21) Appl. No.: 11/174,130

(22) Filed: Jun. 30, 2005

(51) Int. Cl. H04M 1/00

(52) U.S. Cl. 455/556.1

(57) ABSTRACT

Methods and systems are provided for controlling the functions of a handheld multifunction device based on the orientation of the device. The multifunction device can be held in a plurality of orientations including a vertical orientation and a horizontal orientation. The multifunction device includes a user interface that includes a display; and a plurality of applications that provide the device with respective functions, the plurality of applications comprising at least two of organizer, communication, and entertainment functions, wherein at least a portion of the application include different modes of operation. The device further includes control means for detecting an orientation of the multifunction device and for automatically switching between the plurality of applications based on the detected orientation.

### FIELD OF THE INVENTION

The present invention relates to a handheld multifunction device, and more particularly to a method and system for controlling the functions of the handheld multifunction device based on the orientation of the device.

### BACKGROUND OF THE INVENTION

Many grandiose attempts have been made to merge discrete electronic products into a single device. Examples of such devices include desktop office products that have combination scanner, fax, and copier functions; and handheld mobile devices have combination personal digital assistants (PDAs), cell phone, MP3 player or camera functions. As chip integration increases, the technical limitations will cease to matter. However, such multifunction devices continue to be plagued with user-interface problems, particularly with hand-held multifunctional devices. Some believe that user interface issues have prevented a convergence of functions in a single device without serious compromises.

Some prior techniques have attempted to address the user interface problems by controlling the content displayed on the device based on the orientation of either the content itself or on the position of one or more hardware elements on the device. For example, US Patent Application 2004/0204130 discloses a hand-held wireless communication device that automatically detects whether the device has accessed a standard web page, which has a landscape orientation, or a wireless web page, which has a portrait orientation, and automatically displays the accessed web page in the appropriate orientation on the device's display. US Patent Application 2003/0203747 discloses a foldable portable telephone that has a screen that can be rotated into a portrait or landscape position. Based on the position on the screen, images are then displayed in the screen in a portrait or landscape state, accordingly. US Patent Application 2005/0090288 discloses a communication terminal having a multi-orientation user interface in which the display content and soft labels for keys are automatically changed so that the content and the soft label are both readable and usable with the terminal in different orientations.

Although these prior techniques may improve the usability of the hand-held devices by controlling the orientation of the content displayed during a particular function of the device, they fail to provide an adequate solution for controlling the functions of the multifunction device. That is, although the content displayed during a particular function of multifunction devices is made more readable, the multifunction devices still require the user to memorize button sequences and/or to access a plethora of menus in order to control the functions themselves.

### BRIEF SUMMARY OF THE INVENTION

The present invention provides a multifunction device, which can be held in a plurality of orientations including a vertical orientation and a horizontal orientation. The multifunction device includes a user interface that includes a display; and a plurality of applications that provide the device with respective functions, the plurality of applications comprising at least two of organizer, communication, and entertainment functions, wherein at least a portion of the application include different modes of operation. The device further includes control means for detecting an orientation of the multifunction device and for automatically switching between the plurality of applications based on the detected orientation.

According to the method and system disclosed herein, the present invention simplifies the user interface of the device by automatically changing functions of the device and the behavior of the user interface components, including displayed content, content orientation, and functions of the buttons, in response to how a user holds the multifunction device during operation.

### BRIEF DESCRIPTION OF SEVERAL VIEWS OF THE DRAWINGS

FIG. 1 is a block diagram of an embodiment of a handheld multifunction device for use in accordance with the present invention.

FIG. 2 is a flow diagram illustrating the process for controlling functions of the handheld multifunction device based on device orientation in accordance with a preferred embodiment of the present invention.

FIGS. 3 through 6 are diagrams showing a handheld multifunction device in an exemplary embodiment, and the changes that occur in the user interface when applications and their functions are switched in response to changes in the orientation of the device.

FIG. 7 is a block diagram illustrating a portion of the hardware components of the handheld multifunction device shown in FIG. 1, and the software components of the device for implementing the present invention in an exemplary embodiment.

FIG. 8 is a flow diagram illustrating the process for automatically switching between function applications of the handheld multifunction device based on orientation of the device in accordance with a preferred embodiment of the present invention.

FIGS. 9A through 9C are diagrams illustrating axis of rotation for the device.

FIG. 10 is a graph illustrating the hysteresis function switching feature according to the preferred embodiment.

### DETAILED DESCRIPTION OF THE INVENTION

The present invention relates to a method and system for controlling the functions of a handheld multifunction device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Methods and systems are provided for controlling the functions of a handheld multifunction device based on the orientation of the device. Based on how a user holds the multifunction device during operation and changes its orientation, the functions of the device are automatically changed, including the behavior of the user interface components, (e.g., buttons, displays, speakers, and the like) thereby simplifying the user interface.

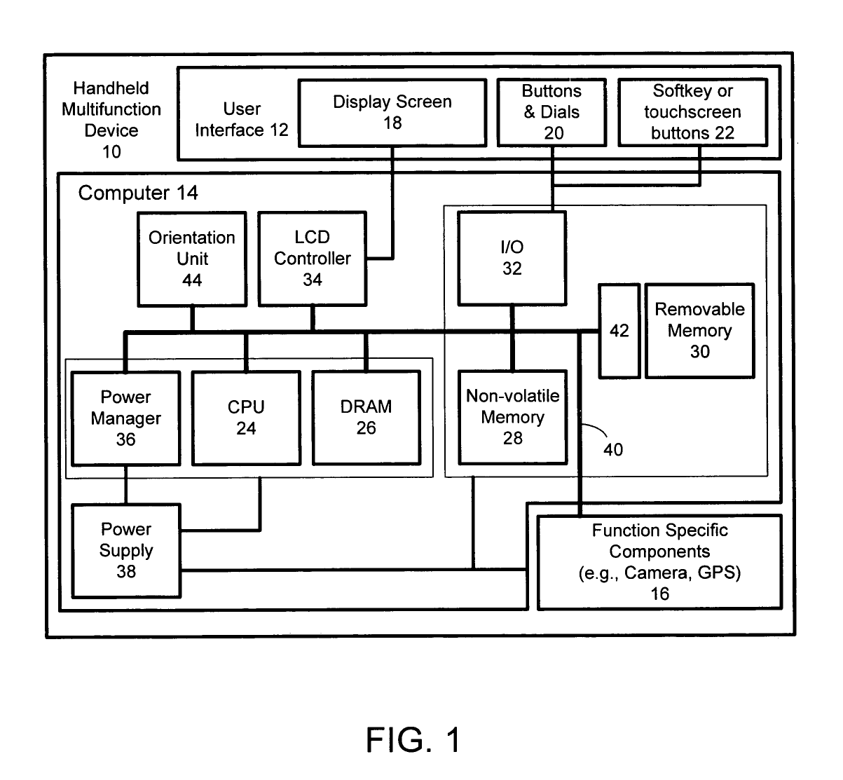

Referring now to FIG. 1, a block diagram of an embodiment of a handheld multifunction device is shown. The handheld multifunction device 10 preferably comprises a user interface 12, a computer 14, and function specific components 16. The user interface 12 includes an output device such as a display screen 18 (e.g., LCD, touchscreen, OLED, etc.), and input devices including hardware buttons and dials 20, and one or more optional touchscreen buttons 22. Alternatively, hardware buttons with software-controlled labels nearby on the display, called soft keys, can be used. The function specific components 16 include hardware for supporting the various functions of the multifunction device, such as an imaging device (e.g., a charged coupled device (CCD) or a CMOS sensor) for supporting a camera function, or a GPS unit for supporting a GPS function, for instance.

The computer 14 preferably comprises a central processing unit (CPU) 24, a dynamic random access memory (DRAM) or static random access memory (SRAM) 26, a nonvolatile memory 28, a removable memory 30, an input/output interface (I/O) 32, a display controller 34, a power manager 36, a power supply 38, and a system bus 40 to which the above-identified components are connected. In the preferred embodiment, CPU 24 is capable of concurrently running multiple software routines to control the various processes of the mutifunction device 10 within a multithreaded or multiprocessing environment. Although CPU 24 is preferably a microprocessor, one or more DSP's (digital signal processor) or ASIC's (Application Specific Integrated Circuit) containing the CPU could also be used. DRAM 26 is a contiguous block of dynamic or static memory that may be selectively allocated for various storage functions, such as executing software applications. Nonvolatile memory 28, which may typically comprise a conventional read-only memory or flash memory, stores a set of computer-readable program instructions that control the operation of the multifunction device 10. Removable memory 30 serves as an additional data storage area and is preferably a non-volatile device, such as a flash disk, that is readily removable and replaceable by the user of the device 10 via buffers/connector 42. The I/O 32 is an interface device allowing communication to and from computer 14. The I/O 32 permits an external host computer (not shown) to connect to and communicate with the computer 14. The I/O 32 also interfaces with the components of the user interface 12. The display controller 34 accesses the DRAM 26 and transfers display data to the display screen 18 for display. The power supply 38 supplies operating power (from external power or internal batteries) to the various components of the device 10. The power manager 36 communicates with the power supply 38 and coordinates power management operations for the device 10. According to the preferred embodiment, the device 10 further includes an orientation unit 44 that senses the current physical position of the device 10 during operation of the device 10 and sends orientation signals to the CPU 24 that are used to determine the current orientation of the device 10.

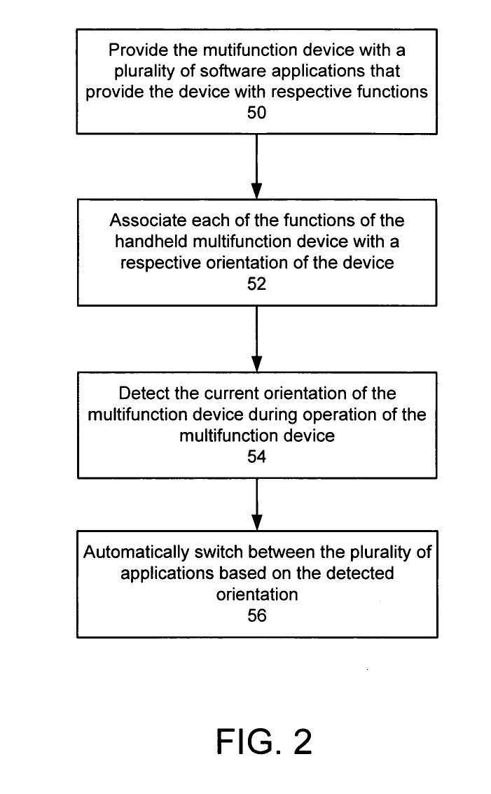

FIG. 2 is a flow diagram illustrating the process for controlling functions of the handheld multifunction device based on device orientation in accordance with a preferred embodiment of the present invention. The process begins in step 50 by providing the multifunction device 10 with a plurality of software applications that provide the device 10 with respective functions. The software applications may provide a handheld device 10 with functions that may generally be categorized as organizer, communication, entertainment, and utility functions. Examples of organizer functions include a PDA and device configuration functions. Examples of communication functions include a cell phone, web browsing, email, and text messaging. Examples of entertainment functions include an MP3 player, a game player, and a multimedia player. Examples of utility functions include a camera and a GPS position device.

As used herein, the functions provided by the applications are discrete operating functions of the device, which may or may not be supported by function specific hardware, and some of the functions may further include different modes of operation. For example, the camera function may include a capture mode for capturing images and a review or play mode for displaying the captured images on the display screen 18. In an alternative embodiment, a single application may provide more than one discrete function. The user interface of these applications should be designed to take advantage of the orientation that will be assigned to the application, including button placement and display orientation.

In step 52, each of the functions of the handheld multifunction device 10 are associated with a respective orientation of the device 10. The orientation of the device 10 means the relative position of the device 10 as a whole, for example, as a user holds the device 10. The orientation may be relative to a ground plane or other point of reference separate from the device. In a preferred embodiment, the device 10 is held by a user such that the side of the device containing the display screen 12 faces the user. The user may hold and position the device 10 in a plurality of orientations including, a first vertical orientation, a first horizontal orientation, a second vertical orientation, a second horizontal orientation. In the case of a PDA, for example, the user may hold the PDA in an upright or portrait orientation for typical use. But the user may rotate the PDA on either of its sides, which would place the PDA in a landscape left or right orientation. Or the user may turn the PDA upside down, inverting it from its normal upright orientation.

In step 54, during operation of the multifunction device 10, the current orientation of the multifunction device 10 is detected. In a preferred embodiment, this is accomplished using a combination of the orientation unit 44 and a function control application, as described below.

In step 56, the computer 14 automatically switches between the plurality of applications based on the detected orientation. In a preferred embodiment, when the multifunction device 10 is operating under a current application in a current orientation, and a new orientation is detected, the current application is suspended and the application associated with the new orientation is made active. This causes a change in the behavior of the device 10 in that the content and orientation of the display screen 18 content changes, including any soft key labels, and the functions of the hardware and buttons 20 and soft keys change to implement the functions provided by the new active application.

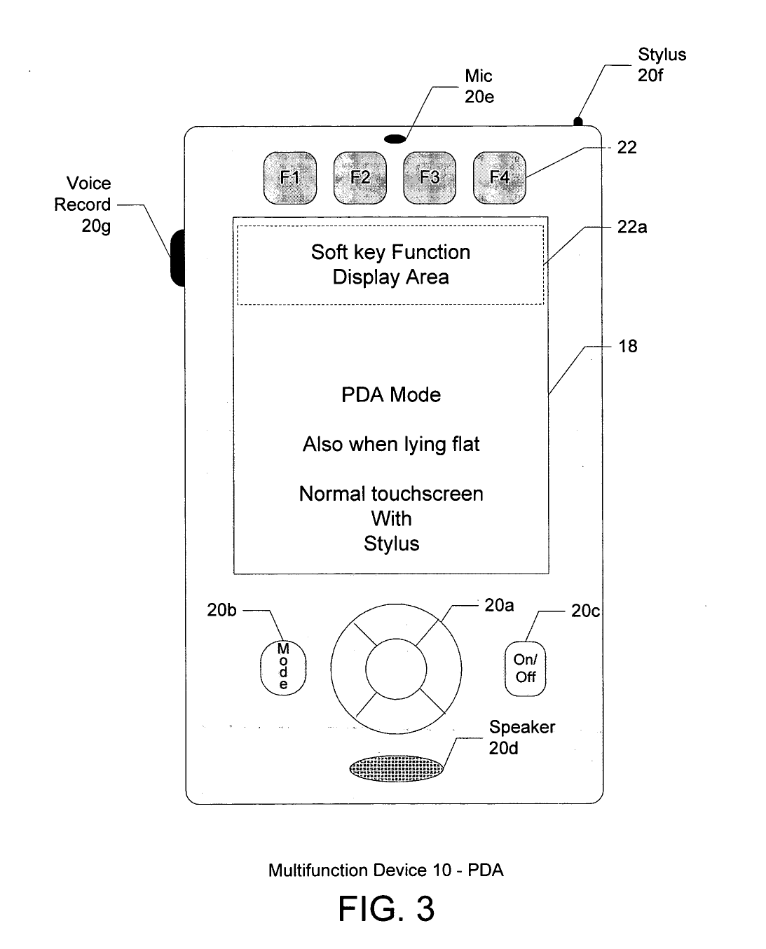

FIGS. 3 through 6 are diagrams showing a handheld multifunction device 10 in an exemplary embodiment, and the changes that occur in the user interface 12 when applications and their functions are switched in response to changes in the orientation of the device. In the examples illustrated by FIGS. 3-6, the display screen 18 is operative as a touchscreen, and the device 10 includes several soft key buttons 22 adjacent to the touchscreen 18, a soft key function display area 22a displayed on the touchscreen 18 for displaying the function of the soft key buttons 22, a four-way controller 20a with center action button, a mode button 20b, an on/off button 20c, a speaker 20d, a microphone 20e, a stylus 20f, and a side button 20g. It should be understood that the display 18, referred to as a touchscreen 18 in the following examples, can include touchscreen capabilities in only a portion of the display 18. Moreover, a separate display and touchscreen can be implemented in the device 10.

Assume for purposes of illustration that the multifunction device 10 includes applications for providing PDA, camera, cell phone, and MP3 player functions. According to the preferred embodiment, the applications are automatically switched based on the orientation of the device 10, as shown. FIG. 3 is a diagram showing that the PDA application has been associated with one of the device's vertical orientations (e.g., upright portrait). When the device 10 is rotated to this upright orientation, the PDA application is automatically made active and the device 10 enters the PDA function in which PDA content is displayed on the touchscreen 18. While in this upright orientation, the user may navigate and control various modes of the PDA function, such as calendar mode, contact mode, notes mode, voice recording, and so on.

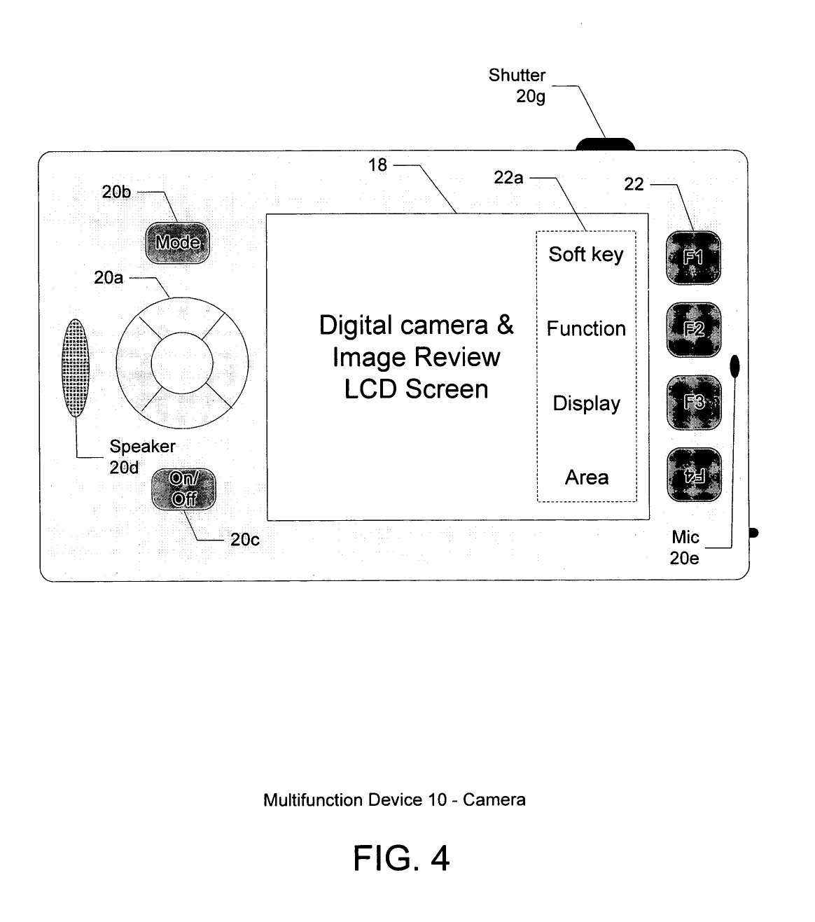

FIG. 4 is a diagram showing that the camera application/function has been associated with one of the device's horizontal orientation (e.g., landscape right,). When the device 10 is rotated to this orientation, the camera application is automatically made active and the device 10 enters the camera function in which camera content is displayed on the touchscreen 18. The camera function may have two modes, live view review. Notice that as the orientation of the device 10 is changed and the applications are switched, the functions of the buttons 20 and soft keys 22 also change. For example, in FIG. 3, button 20g in the PDA function may serve to active voice recordings, while in FIG. 4, button 20g in the camera function may serve as the shutter button for capturing images, where pressing down halfway to S1 position may initiate live view mode, and pressing down to S2 may capture the image.

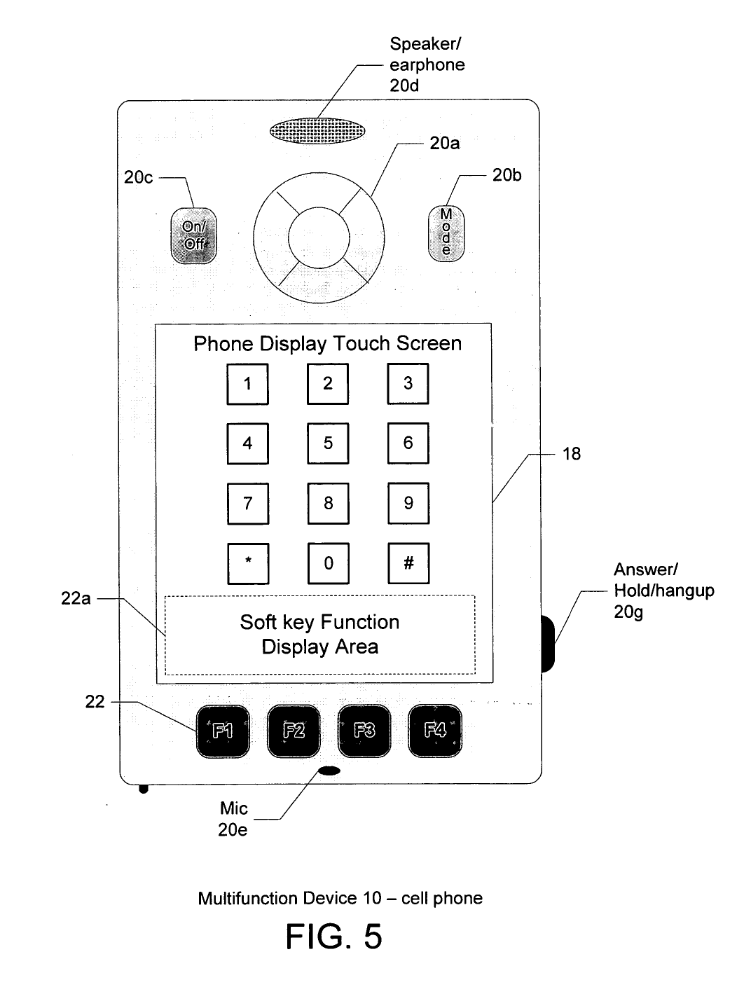

FIG. 5 is a diagram showing that the cell phone application/function has been associated with the device's second vertical orientation (e.g. inverted). When the device 10 is rotated to this inverted orientation, the cell phone application is automatically made active, and the device 10 enters the cell phone function. In this function, a dial keypad for the cell phone may be displayed on the touchscreen 18 in the correct orientation and button 20g may be operative as an answer/hold/hangup button. Also notice that when held to the user's head during a cell phone function, the speaker 20d will be aligned with the user's ear and the microphone 20e will be aligned with the user's mouth.

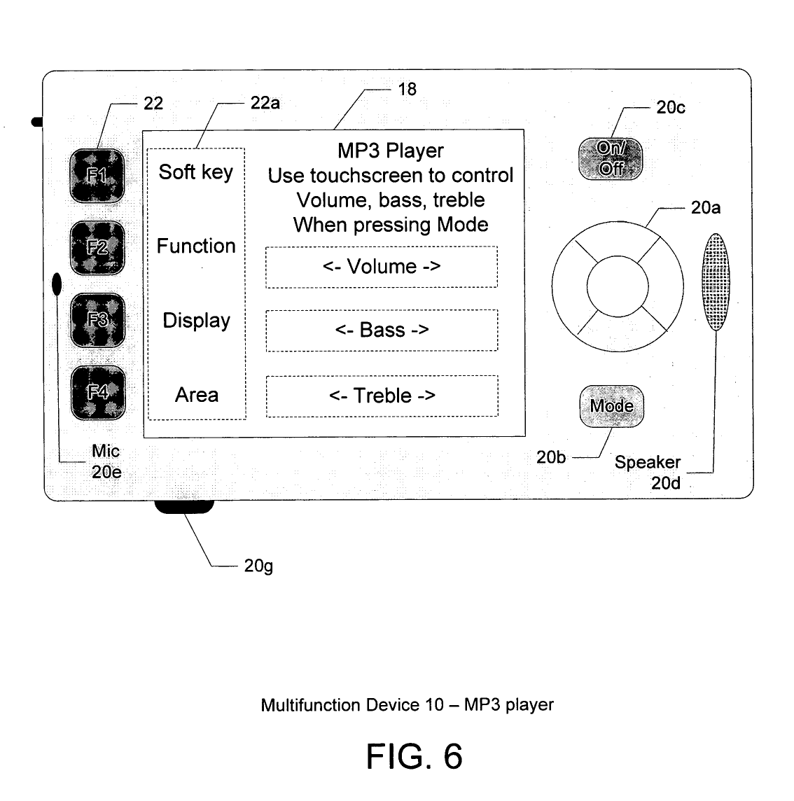

FIG. 6 is a diagram showing that the MP3 player application/function has been associated with the device's second horizontal orientation (e.g., landscape left). When the device 10 is rotated to this orientation, the MP3 player application is automatically made active and the device 10 enters the MP3 player function. During the MP3 player function, the touchscreen 18 may be used to display song titles and MP3 controls, such as volume, base, and treble, for example. Button 20g may be operative as a play/pause button in this orientation.

In one preferred embodiment, the device 10 may be configured to turn-off/on the automatic switching feature to prevent the device 10 from automatically switching applications regardless the orientation of the device. When the automatic switching feature is disabled, the user manually enters and exits functions. Rather than disable the automatic switching feature altogether, one or more of the application functions may be provided with an override setting that disables the automatic switching feature when the device 10 is in a certain mode of a particular function. For example, a “phone call” override setting may be provided for the cell function, which when set, disables the automatic switching feature once the user answers a telephone call. This prevents the unintended consequence of interrupting a telephone call when the user repositions the device.

In another embodiment, one or more of the application functions may be provided with a “forced on” setting that automatically activates the function in response to certain events regardless the detected orientation of the device 10. When the forced-on setting is set within the cell phone function, the device 10 automatically switches to the cell phone function when a call is received, and stays that way until either the ringing ends or the user ends the call (of course the device 10 should be properly orientated to talk, but the cell phone function is forced on). Similarly, in the case where the device 10 is set up for receiving messages or alerts, such as a wireless PDA, a beep or sound may be automatically played to indicate that the user should access the PDA function. This could also be the implemented for phone calls. Alternatively, a message such as “incoming call” or “calendar alert” or “incoming message” could show up on the display screen 18, and the user can either accept (by, for example, orienting the device) or ignore (press the center button in 4-way controller 20a, for example, to cancel the notice).

In the present example, four applications have been associated with the major orientations of the sides of the device 10. However, by also using the front and back of the device, a potential for up to six orientations and six mappings are available. Additional mappings may be accomplished by mapping more than one function to an orientation and providing a mode button or switch to invoke the first or second level of mapping.

In a preferred embodiment, the front and back of the device 10 are also used to provide a face-down (screen-down) and flat orientations (screen-up). In one embodiment, one of the applications/functions (e.g. the PDA application), may be designated as the default application that is also associated with the flat orientation, such that the application is activated not only in its native mapped orientation, but also when the device 10 is laid flat on its back (screen up). In an alternative embodiment, the device 10 remains in whatever function the device 10 was in prior to the device 10 being placed flat. When the device 10 is placed on its front (screen-down), the device 10 may automatically enter a standby state in which all the applications are suspended (the cell phone would still receive calls, incoming messages and calendar alerts would continue to be processed). If the device 10 is not equipped with a function that can request a response from the user, such as a cell phone or PDA with calendar alerts or incoming messages, then the device 10 may alternatively automatically deactivate when placed face-down.

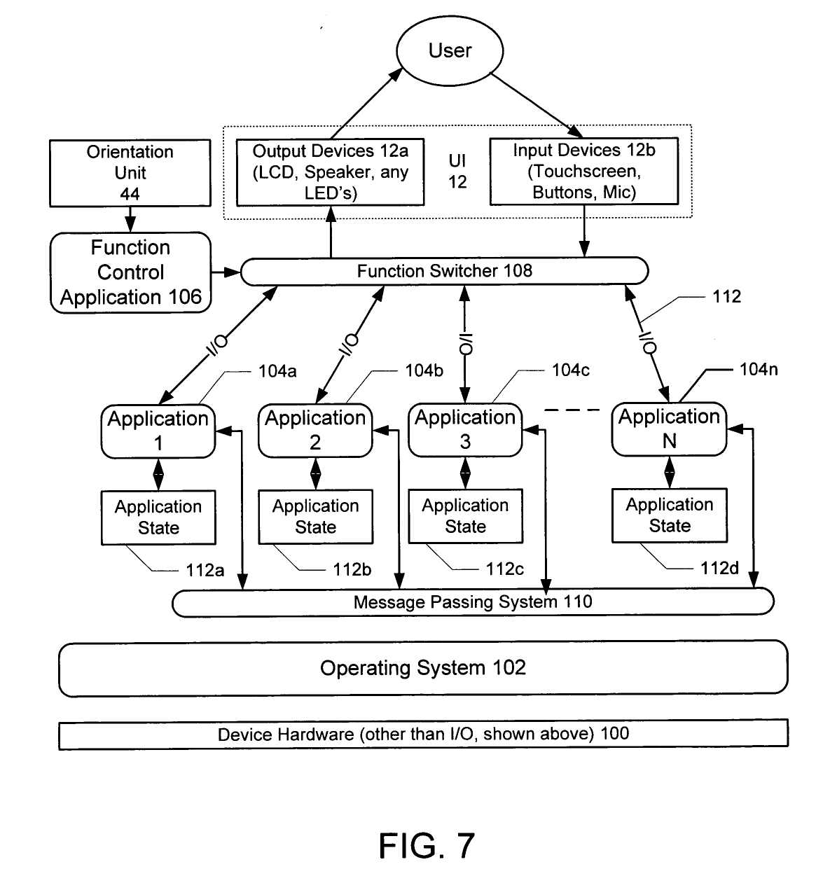

FIG. 7 is a block diagram illustrating a portion of the hardware components of the handheld multifunction device 10 shown in FIG. 1, and the software components of the device 10 for implementing the present invention in an exemplary embodiment. Components shown from FIG. 1 include the user interface 12, and the orientation unit 44. Components of the user interface 12 can be divided into output devices 12a, which include the display screen 18, speaker 20d, and any LED's, and input devices 12b, which may include a touchscreen, buttons and dials 20, and the microphone 20e. The remaining hardware components are shown collectively as device hardware 100.

The device 10 preferably executes an operating system 102, on top of which, execute function applications 104a, 104b, 104c, 104n (collectively referred to as applications 104) that provide the device with its various functions. In accordance with the preferred embodiment, the device 10 further includes a function control application 106, a function switcher 108 and a message passing system 110. The function control application 106 communicates with the orientation unit 44 and the function switcher 108. The function switcher 108 is coupled to the user interface 12 and communicates with the applications 104. Specifically, depending on the orientation selected by the function control application 106, based on information from the orientation unit 44, the function switcher 108 redirects user input/output to the selected application 104a-104c. The deselected applications receive notification that they are suspended, and thus do not attempt to output to the user or receive input from the user, other than the use of the message passing system 110. The message passing system 110 allows alerts and other types of messages from suspended applications to be displayed by the active application, and allows the user to respond to them, causing a response message to be returned to the sending application. Not shown is the override path from the operating system 102 to the Function Control Application 106, where a system call to the operating system by a suspended application can force the selection of the suspended application to become the active application. Likewise, the override can also be triggered by the active application, to force the application to remain active even if orientation changes. A system call to remove the override is also provided.

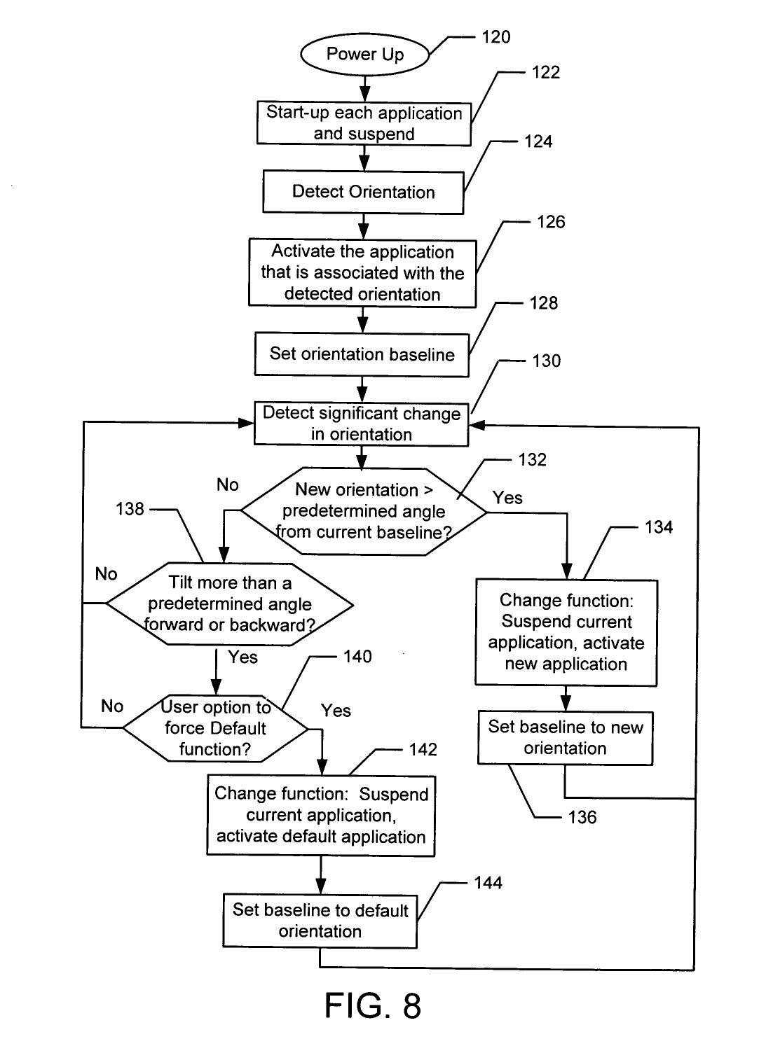

FIG. 8 is a flow diagram illustrating the process for automatically switching between function applications of the handheld multifunction device 10 based on orientation of the device 10 in accordance with a preferred embodiment. The process assumes that the automatic switching feature in the device 10 is enabled, otherwise, the user must manually switch between function applications 104. Referring to both FIGS. 7 and 8, in response to the device 10 being powered-on in step 120, the applications 104 are started and suspended in step 122. This step initializes the application, and creates an initial state for the display. This allows rapid switching to a new application—the application does not have to do anything to prepare the display screen, but rather the operating system, under the command of the function switcher 108, simply sets the display address in memory to the appropriate, already completed display content.

In step 124, the orientation of the device 10 is detected. According to the preferred embodiment, the orientation unit 44, function control application 106, and function switcher 108 provide control means to detect and sense changes in the orientation of the device 10 and to switch the applications 104. To prevent unwarranted switching of applications in response to rapid or small orientation changes, in a preferred embodiment, the function control application 106 uses hysteresis to sense changes in the orientation of the device 10 and to switch the applications 104 accordingly. In other words, the automatic changing of functions lags behind the time the user initially rotates the device 10 out of one orientation into another.

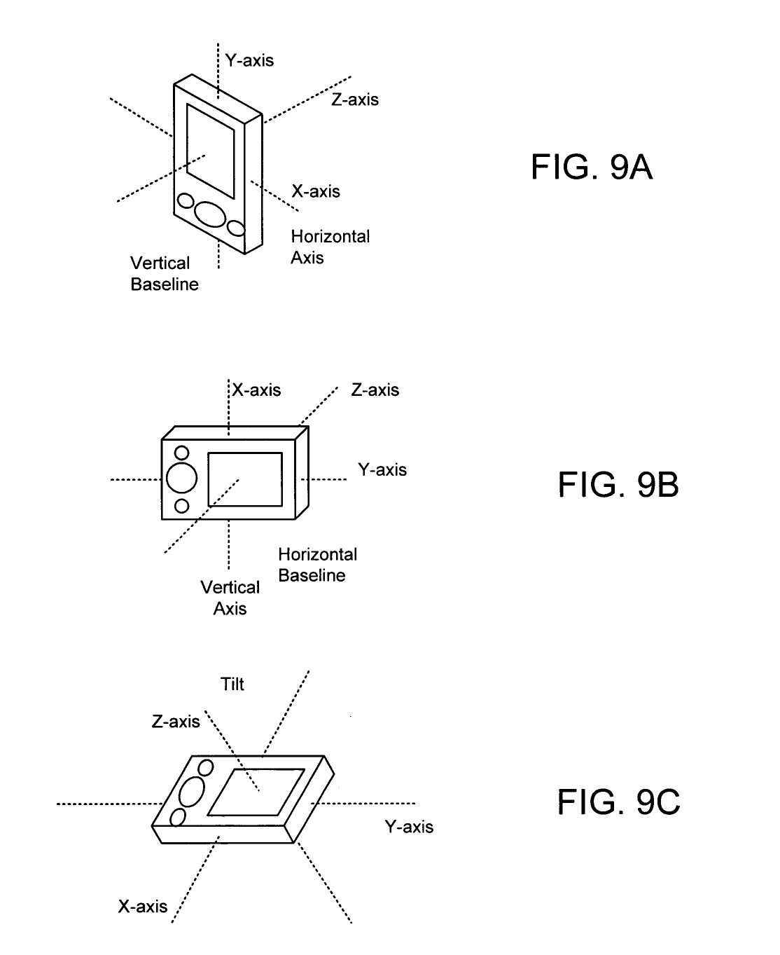

Detecting a change in orientation is implemented as follows. First, the angle of rotation of the device 10 is measured from the rotation of the device 10 around an axis that is normal to the display 118 and, which is parallel to a ground plane when the device is held by the user, as illustrated in FIG. 9A.

FIGS. 9A through 9C are diagrams illustrating axis of rotation for the device. FIG. 9A shows the device 10 in a vertical or portrait orientation. FIG. 9B shows the device 10 in a horizontal or landscape orientation. FIG. 9C shows the device 10 being tilted back and forth. As the user holds the device with the display screen 18 facing the user, the device 10 may be described as being positioned relative to the user with an x-axis pointing left and right parallel to a horizontal ground plane, a y-axis pointing up and down parallel to a vertical plane, and a z-axis that is normal to the display screen, pointing forward away from the user's body and parallel with the horizontal ground plane. The orientation of the device 10 is thus measured by the angle of the device 10 as it is rotated around the z-axis along the x, y plane.

Second, the angle of rotation of the device 10 is measured against a baseline angle that is associated with the current orientation. FIG. 9A shows that the vertical baseline is associated with the first and second vertical orientations, and is substantially vertical from the horizontal ground plane (y-axis is vertical). FIG. 9B shows that a horizontal baseline is associated with the first and second horizontal orientations, and is substantially horizontal from the vertical plane (x-axis of the device is now vertical). The tilt angle shown in FIG. 9C is calculated as the device 10 is rotated about the x-axis or y-axis depending on if it is positioned in the horizontal or vertical orientation, and is used to determine when the device is laid flat, face-up or face-down.

In operation, the function control application 106 uses orientation signals received from the orientation unit 44 to detect the orientation of the device 10. In one embodiment, the orientation unit 44 may be implemented as a solid-state circuit that measures acceleration angles indicating the direction of gravity and the angle of the unit 44 from the normal of the chip. In a second embodiment, the orientation unit 44 may be implemented as a mechanical switch, such as a cube which contains a metal ball. Each corner of the cube may have an indentation and contact for trapping the ball as the device 10 is rotated. The presence of the ball in one of the corner contacts indicates the orientation of the device 10 (e.g., upright, left, right, inverted, face-up, and face down). Alternatively, the ball may be non-metallic, and the sensing done by an LED/light sensor combination. If the signals received from the orientation unit 44 are angles, then the function control application 106 uses the angles to determine the closest baseline orientation.

After the orientation of the device 10 is detected, in step 126 the function control application 106 activates the application 104 that is associated with the detected orientation. In step 128, the function control application 106 sets the orientation baseline for the current orientation.

In step 130, the function control application 106 detects whether there is a significant change in orientation of the device 10. If yes, then in step 132, the function control application 106 determines whether the new orientation is greater than a predetermined function switching angle measured from the baseline of the current orientation. In a preferred embodiment, the predetermined function switching angle is selected such that a large degree of hysteresis exist when switching between the applications 104. Preferably, a function switching angle of at least 60° measured from the baseline of the current orientation is used as a threshold for switching applications 104. In an alternative embodiment, a range anywhere from 45° to 90° measured from the baseline may be used to determine when to switch applications 104.

If the new orientation is greater than the predetermined angle from the baseline of the current orientation, then in step 134, the function control application 106 switches functions by suspending the current application 104 and activating the application 104 associated with the new orientation. In step 136, the function control application 106 sets the orientation baseline based on the new orientation. The function control application 106 also identifies the newly activated application 104 to the function switcher 108 and operating system 102. In response, the function switcher 108 routes I/O's 112 of the active application 104 to the user interface 112. According to a further embodiment, the applications 104 may communicate with one another using the message passing system 110, whether the applications 104 are in the active or suspended state. In this case, suspended means not interacting with the user. Certain portions of the suspended application may be active in the sense that they respond to incoming signals from hardware components specifically associated with them, such as a calendar event timeout, or a phone call. When such an event occurs, the suspended application may interact with the signal source device or system, and communicate with the user via the message passing system 110, or by calling the operating system 102 with a request to force the application to become the active application. Note that if an application already has forced the selection of itself, any second application requesting a forced transfer to become the active application may be denied, and the message passing system 110 may be the only way to notify the user. Alternatively, each application may be assigned a priority value, and may even have variable priority based on events or activities, such that a decision can be made by the operating system 102 and function switcher 108 based on priority. In any case, if a suspended application's request to force itself to be active is denied, the message passing system 110 is available to notify the user to take appropriate action, via the user interface of the active application.

Referring again to FIG. 7, when an application 104 is suspended, its application state 112 is saved for use in restoring the active application 104 at a later time. This way, functions resume where they leave off. For example, if the user is entering contact information during the PDA function and changes orientation such that a new function is invoked, the current application state of the PDA function is saved, including the state of the display. When the user returns the device 10 to the orientation associated with the PDA function, the application state 112 is retrieved and the contact information screen is redisplayed, including any data the user had entered.

Referring again to FIG. 8, if the new orientation is less than the predetermined angle from the baseline of the current orientation in step 132, then in step 138, the function control application 106 determines if the device 10 is tilted more than a predetermined function switching angle forwards or backwards, as shown in FIG. 9C. As described above, in a preferred embodiment, the predetermined function switching angle is at least 60°. In an alternative embodiment, a range anywhere from 45° to 90° may be used. Note that the tilt angle switching point may be even larger than the z-axis orientation switching angle. For example, tilts more than 75° may be required to take action from a tilt around the x-axis (landscape orientation) or y-axis (portrait orientation).

If the device 10 is tilted more than the predetermined angle, indicating a flat orientation, then in step 140 the function control application 106 determines if any of the applications 104 has been designated as the default application. If so, then in step 142 the function control application 106 switches functions by suspending the current application 104 and activating the application 104 associated with the new orientation, and the baseline is set to the default orientation in step 144. If the orientation is face-down, then all applications may be suspended and the unit 10 put into a low power state. Alternatively, the face-down orientation can be used for a sixth function, such as a meeting recorder, for example. To conserve power, the display is turned off (it can't be viewed anyway), and the unit may appear to be off to others present.

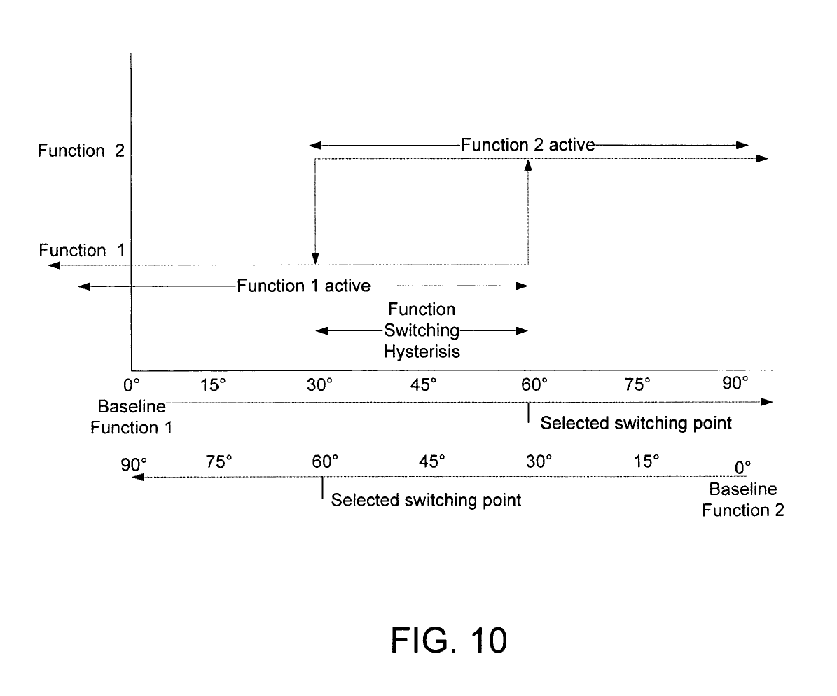

FIG. 10 is a graph illustrating the hysteresis function switching feature according to the preferred embodiment. The graph shows the timing of switching between functions 1 and 2. The top x-axis in the graph illustrates orientation angles measured from the baseline of function 1, which is 0°. The bottom x-axis in the graph illustrates orientation angles measured from the baseline of function 2, which is shown in the opposite direction. If function 1 is the currently active function, the x-axis arrow associated with function 1 in the graph show the permissible angles for which the device may be rotated in order for function 1 to remain active as measured from the baseline for function 1, i.e., angles away from the baseline of up to the selected switching angle, shown here as 60° from baseline. If function 2 is the currently active function, the x-axis arrow (now in the reverse direction) indicates the permissible angles for which the device may be rotated in order for function 2 to remain active, as measured from the baseline for function 2, again shown here at 60°.

The graph shows that since changes in orientation are calculated based on changes in the angle of the device's orientation from the baseline of the current orientation, the number of inadvertent application changes is reduced. For example, assume the device 10 is turned and held in the upright vertical orientation, which is associated with function 1. The device 10 will activate function 1, e.g., the PDA function, and will remain in the PDA function even if the device 10 is rotated 20° because the change in orientation is calculated from the vertical baseline, and not from the current or last position of the device 10. Once the device 10 is rotated more than the predetermined angle, 60° in this example, the device 10 switches functions by suspending function 1 and activating function 2, e.g., the camera function, and sets the baseline to horizontal (90°), even before the device 10 fully reaches the horizontal orientation.

Now that the baseline has been changed, the device must be rotated back 30° in relation to the function switching angle (i.e., 60°) or 60° in relation to the current baseline for function 2. Thus every time functions are switched, the baseline and therefore the switch point changes so that more than a 45° rotation of the device 10 is always required to cause another function change.

A method and system for controlling the functions of a handheld multifunction device has been disclosed in which functions are automatically switched based on orientation of the device. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A multifunction device that can be held in a plurality of orientations, including a vertical orientation and a horizontal orientation, the multifunction device, comprising:
a user interface including a display;
a plurality of applications that provide the multifunction device with respective functions, the plurality of applications comprising at least two of organizer, communication, utility, and entertainment functions, wherein at least a portion of the application include different modes of operation; and
control means for detecting an orientation of the multifunction device and for automatically switching between the plurality of applications based on the detected orientation.

2. The multifunction device of claim 1 wherein the plurality of applications comprise at least two of a PDA, cell phone, web browsing, email, text messaging, MP3 player, game player, multimedia player, camera, and GPS position device.

3. The multifunction device of claim 1 wherein the multifunction device can be held in a plurality of orientations including, a first vertical orientation, a first horizontal orientation, a second vertical orientation, a second horizontal orientation, and wherein a first one of the applications is associated with the first vertical orientation, a second one of the applications is associated with the first horizontal orientation, a third one of the applications is associated with the second vertical orientation, and a fourth one of the applications is associated with the second horizontal orientation.

4. The multifunction device of claim 1 wherein the multifunction device further includes a flat orientation and a face-down orientation, wherein one of the applications is designated as the default application and is also mapped to the flat orientation, and wherein when the multifunction device is in the face-down orientation, the multifunction device enters a standby state in which all of the applications are suspended.

5. The multifunction device of claim 1, wherein the control means provides a function that, when activated, prevents the control means from automatically switching between the plurality of applications, regardless of the detected orientation, at least until after the function is deactivated.

6. The multifunction device of claim 1, wherein one or more of the applications is provided with an override setting that disables the automatic switching when the multifunction device is in a certain mode of a particular function.

7. The multifunction device of claim 1, wherein one or more of the applications is provided with a setting that automatically activates the function in response to certain events regardless of the detected orientation of the multifunction device.

8. The multifunction device of claim 1 wherein when the control means switches between a currently active application and a new application, the control means suspends the currently active application and saves a current state of the currently active application for use in restoring the currently active application.

9. The multifunction device of claim 1 wherein automatically switching between the applications causes a change in the behavior of the multifunction device such that content and orientation of the content on the display changes.

10. The multifunction device of claim 1 wherein the user interface comprises a touch screen that displays soft keys, wherein an orientation and function of the soft keys change when the applications are switched.

11. The multifunction device of claim 1 wherein the user interface comprises at least one hardware button, wherein a function of the at least one hardware button changes when the applications are switched.

12. The multifunction device of claim 1 wherein the orientation of the multifunction device is measured from a rotation of the multifunction device around an axis that is normal to the display and that is parallel to a ground plane.

13. The multifunction device of claim 1 wherein when the multifunction device is turned-on, the control means is functional for:
detecting an angle of orientation of the multifunction device,
activating an application that is associated with the orientation closest to the detected angle of orientation; and
placing the other applications in a suspended state.

14. The multifunction device of claim 3 wherein the control means detects a change from a current orientation to a new orientation when a change in orientation greater than a predetermined function switching angle is measured from a baseline of the current orientation, wherein the baseline for the first and second vertical orientations is vertical from a ground plane, and the baseline for the first and second horizontal orientations is horizontal from the ground plane.

15. The multifunction device of claim 14 wherein the predetermined function switcher angle is selected such that a large degree of hystereris exists in the switching between the applications.

16. The multifunction device of claim 15 wherein the function switcher angle is set to between 45° and 90° from the baseline of the current orientation.

17. The multifunction device of claim 14 wherein once the control means determines a change in orientation has occurred, the control means suspends a currently active application, activates an application mapped to the new orientation, and sets the baseline to the new orientation.

18. The multifunction device of claim 17 wherein the control means includes an orientation sensor for detecting an angle of orientation of the multifunction device.

19. The multifunction device of claim 18 wherein the control means further includes a function switcher for routing input/output of the active application to the user interface.

20. The multifunction device of claim 19 wherein the control means further includes a function control application functional for:
receiving an orientation signal from the orientation sensor,
determining the orientation of the multifunction device based on the orientation signal,
based on the determined orientation, suspending a currently active application and activating an application associated with the detected orientation, and
identifying the activated application to the function switcher.

21. The multifunction device of claim 1 further including a message passing system for allowing applications to communicate with one another whether active or suspended.

22. A method for controlling functions of a multifunction device, wherein the multifunction device can be held in a plurality of orientations including a vertical orientation and a horizontal orientation, the method comprising:
providing the multifunction device with a plurality of applications that provide the multifunction device with respective functions, wherein at least a portion of the functions include multiple modes of operations;
associating each of the functions to a respective orientation of the multifunction device;
during operation of the multifunction device, detecting a current orientation of the multifunction device; and
automatically switching between the plurality of applications based on the detected orientation.

23. The method of claim 22 wherein the plurality of applications comprise at least two of a PDA, cell phone, web browsing, email, text messaging, MP3 player, game player, multimedia player, camera, and GPS position device.

24. The method of claim 22 wherein the multifunction device can be held in a plurality of orientations including, a first vertical orientation, a first horizontal orientation, a second vertical orientation, a second horizontal orientation, and wherein associating each of the functions to a respective orientation of the multifunction device includes associating a first one of the applications with the first vertical orientation, associating a second one of the applications with the first horizontal orientation, associating a third one of the applications with the second vertical orientation, and associating a fourth one of the applications with the second horizontal orientation.

25. The method of claim 22 wherein the multifunction device further includes a flat orientation and a face-down orientation, wherein one of the applications is designated as the default application and is also mapped to the flat orientation, and wherein when the multifunction device is in the face-down orientation, the multifunction device enters a standby state in which all of the applications are suspended.

26. The method of claim 22, wherein the control means provides a function that, when activated, prevents the automatic switching between the applications, regardless of the detected orientation, at least until after the function is deactivated.

27. The method of claim 22, wherein one or more of the applications is provided with an override setting that disables the automatic switching when the multifunction device is in a certain mode of a particular function.

28. The method of claim 22, wherein one or more of the applications is provided with a setting that automatically activates the function in response to certain events regardless of the detected orientation of the multifunction device.

29. The method of claim 22 wherein automatically switching between the plurality of applications includes suspending an application associated with the current orientation and activating an application associated with a new orientation.

30. The method of claim 22 wherein the multifunction device includes a display and wherein automatically switching between the applications includes causing a change in the behavior of the multifunction device such that content and orientation of the content on the display is changed.

31. The method of claim 22 wherein the multifunction device includes a user interface and the user interface comprises a touch screen that displays soft keys, wherein automatically switching between the applications includes changing an orientation and function of the soft keys.

32. The method of claim 22 wherein the multifunction device includes a user interface and the user interface comprises at least one hardware button, wherein automatically switching between the applications includes changing a function of the at least one hardware button.

33. The method of claim 29 wherein suspending the application associated with the current orientation includes saving a current state of a currently active application for use in restoring the currently active application.

34. The method of claim 22 wherein detecting a current orientation includes detecting a change between a current orientation and a new orientation.

35. The method of claim 34 wherein detecting the current orientation is performed by measuring a rotation of the multifunction device around an axis that is normal to the display and that is parallel to a ground plane.

36. The method of claim 35 wherein detecting the change from the current orientation to the new orientation occurs when a change in orientation greater than a predetermined function switching angle is measured from a baseline of the current orientation, wherein the baseline for the first and second vertical orientations is vertical from a ground plane, and the baseline for the first and second horizontal orientations is horizontal from the ground plane.

37. The method of claim 36 further including selecting the predetermined function switcher angle such that a large degree of hystereris exist in the switching between the applications.

38. The method of claim 37 further including setting the function switcher angle to between 45° and 90° from the baseline of the current orientation.

39. The method of claim 37 further including in response to detecting a change in orientation, suspending a currently active application, activating an application mapped to the new orientation, and setting the baseline to the new orientation.

40. A computer-readable medium containing program instructions for controlling functions of a multifunction device, wherein the multifunction device can be held in a plurality of orientations including a vertical orientation and a horizontal orientation, the program instructions for:
providing the multifunction device with a plurality of applications that provide the multifunction device with respective functions, wherein at least a portion of the functions include multiple modes of operations;
associating each of the functions to a respective orientation of the multifunction device;
during operation of the multifunction device, detecting a current orientation of the multifunction device; and
automatically switching between the plurality of applications based on the detected orientation.
